(19) United States
(12) Patent Application Publication
(10) Pub. No.: US 2001/0029217 A1
(43) Pub. Date: Oct. 11, 2001

(54) Transport belt for transporting a fiber strand to be condensed and method of making same

(75) Inventor: Gerd Stahlecker, Eislingen/Fils (DE)

Correspondence Address: Evenson, McKeown, Edwards & Lenahan, P.L.L.C., 1200 G Street, N.W., Suite 700, Washington, DC, 20005, US

(73) Assignee: Wilhelm Stahlecker GmbH

(21) Appl. No.: 09/818,543

(22) Filed: Mar. 28, 2001

(30) Foreign Application Priority Data
Apr. 11, 2000 (DE) 100 18 002.7

(51) Int. Cl. F16G 1/04

(52) U.S. Cl. 474/266; 474/267

(57) ABSTRACT

A transport belt for transporting a fiber strand to be condensed through a suctioned condensing zone of a spinning machine, an air-permeable, woven transport belt is provided. This transport belt is driven on the one hand by means of a friction drive of a nipping roll and on the other hand slides at the same time over a stationary sliding surface. The transport belt is woven from fine threads in such a way that, despite a small mesh width, a good flow rate of air is achieved. At regular intervals, coarser threads are woven in transversely to the transport direction, whose structure is such that the friction between a nipping roller, which effects the friction drive, and the transport belt is increased.

### BACKGROUND AND SUMMARY OF THE INVENTION

This application claims the priority of German Patent Document 100 18 002.7, filed in Germany, Apr. 11, 2000, the disclosure of which is expressly incorporated by reference herein.

The present invention relates to an air-permeable, woven transport belt made of fine synthetic fibers, which transport belt is provided for a friction drive by means of a nipping roller and for simultaneous sliding over a stationary sliding surface, and for transporting a fiber strand to be condensed through a suctioned condensing zone of a spinning machine, whereby at regular intervals coarse synthetic threads are woven into the transport belt transversely to the transport direction of the fiber strand.

In the case of a transport belt of this type (German published patent application 198 37 182, FIG. 7, corresponding U.S. patent application Ser. No. 09/361,525, filed Jul. 27, 1999), the coarse threads give the transport belt a reinforcing skeleton. In contrast, in the spaces located between the coarse threads, the fine threads are woven in such a way that a desired fine perforation with good air flow is attained.

The transport belt must meet very varying requirements with regard to its structure. On the one hand, the transport belt should be of sufficiently low friction, so that it slides on a stationary sliding surface without any great resistance. On the other hand, the surface of the transport belt facing away from the sliding surface should be designed in such a way that it is suitable for a friction drive.

It is an object of the present invention to improve a transport belt of the above mentioned type with regard to its friction drive.

This object has been achieved in accordance with the present invention in that the structure of the coarse threads is such that they increase the friction between the nipping roller and the transport belt.

The transversely woven-in coarse threads in the transport belt serve now not only, as in the case of the known transport belt, to increase the stiffness in transverse direction, but they also take on a further function, namely to give the transport belt on its side facing away from the sliding surface such a surface structure that a nipping roller can drive the transport belt without any great slip by means of friction. This, of course, should not overly increase the sliding resistance in relation to the sliding surface.

The fine threads as well as the coarse threads are preferably filament threads made of a suitable synthetic material, for example polyamide. The diameter of the fine threads is chosen in such a way that the woven fabric of the transport belt provides the highest possible air flow in spite of a possible narrow mesh. This is in particular the case when the diameter of the fine filaments is smaller than the clear mesh width.

The diameter of the coarse threads, extending transversely to the transport direction of the fiber strand, should measure at least ten times the diameter of the fine threads. The distance of the coarse threads to one another should not impair the air flow through the transport belt, but in regard to a good friction take-along, should also not be too large. The distance could, for example, correspond to the radius of the nipping roller.

The gripping properties for an external friction drive can also be improved in that the normally twist-free coarse threads are additionally provided with a twist. A further increase of the gripping properties can be achieved in that two twisted threads are joined together to form a ply yarn, whereby naturally attention must be paid that the sliding ability in relation to the sliding surface is maintained.

Using a transport belt of this design, a fiber strand to be condensed can be transported through a condensing zone of a spinning station. Condensing of a fiber strand drafted by a drafting unit serves to laterally gather the fibers lying parallel to one another in the fiber strand and to make the fiber strand so narrow that no spinning triangle occurs during the subsequent introduction of a spinning twist at the nipping point, which is effected by the nipping roller. A non-condensed fiber strand would result in the known way in a spinning triangle, in which outerlying fibers do not contribute to a sufficient degree to the tensile strength of the arising thread. When, however, due to the condensing of the fiber strand, the spinning triangle is eliminated by means of an airstream , the forming thread becomes more tear resistant, more even and less hairy after the spinning twist has been imparted.

### BRIEF DESCRIPTION OF THE DRAWINGS

These and further objects, features and advantages of the present invention will become more readily apparent from the following detailed description thereof when taken in conjunction with the accompanying drawings wherein:

FIG. 1 is a partly sectional side view through the area of a condensing zone, constructed according to preferred embodiments of the present invention;

FIG. 2 is a view in the direction of arrow II of FIG. 1 onto the condensing zone, whereby several components have been omitted; and

FIG. 3 is a greatly enlarged partial view of FIG. 2 onto a woven transport belt according to the present invention.

### DETAILED DESCRIPTION OF THE DRAWINGS

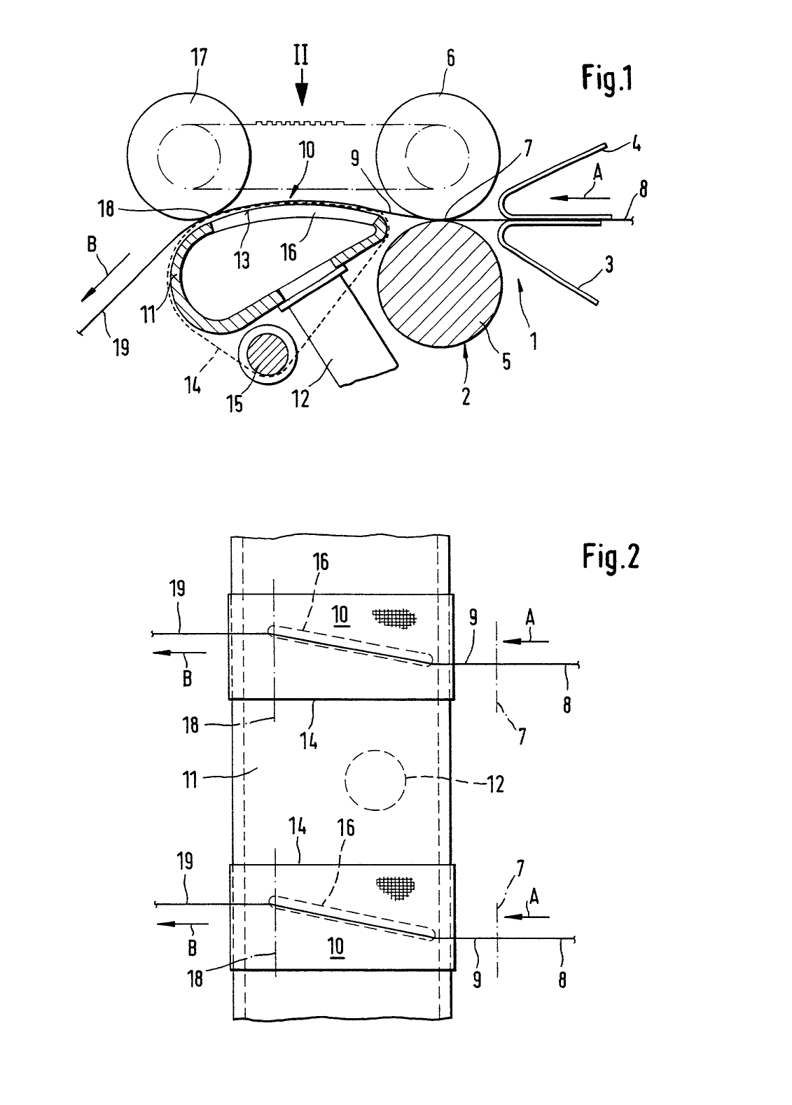

The FIGS. 1 and 2 show in the area of the present invention a section of a spinning machine, in particular a ring spinning machine. The end area of a drafting unit 1 can be seen, comprising a front roller pair 2 and an apron belt pair arranged upstream thereof and comprising a bottom apron 3 and an upper apron 4. The front roller pair 2 comprises a driven bottom cylinder 5 extending continuously in machine longitudinal direction, as well as a top roller 6, provided for each spinning station of a multi-station machine. The front roller pair 2 forms a front nipping line 7 of the drafting unit 1 and marks the end of the drafting zone arranged upstream therefrom.

In the drafting unit 1, a sliver or a roving 8 is guided through in transport direction A in a known way and drafted to the desired degree of fineness. Directly downstream of the front nipping line 7 lies a drafted fiber strand 9 which is still twist-free.

If the fiber strand 9 were imparted a spinning twist immediately, then the feared spinning triangle would occur at the front nipping line 7. For this reason, in a condensing zone 10 downstream of the drafting zone, the drafted fiber strand 9 is first bundled or condensed by means of lateral gathering, so that when the spinning twist is subsequently imparted, a spinning triangle does not occur.

A suction channel 11 in the form of a hollow profile is located in the condensing zone 10, in which suction channel 11 a vacuum prevails and which extends over a plurality of spinning stations, as can be seen in FIG. 2. The suction channel 11 extends preferably along a machine section and is provided at a suitable point with a vacuum conduit 12, which leads to a vacuum source (not shown).

In the area of the condensing zone 10, the outer contour of the suction channel 11 takes the form of a sliding surface 13, over which an air-permeable transport belt 14 is guided in a sliding manner. In the case of the transport belt 14, a thin and close-meshed woven belt is involved, which is described in more detail below, which belt transports the fiber strand 9 to be condensed through the condensing zone 10. The fiber strand 9 is sucked to the transport belt 14.

The transport belt 14 is guided on the side facing away from the condensing zone 10 over a tension element 15, which at the same time aligns the transport belt 14 in lateral direction.

A suction slit 16, covered by the transport belt 14, is located in the sliding surface 13, which suction slit 16 extends slightly transversely to the transport direction A, so that a light false twist is additionally imposed on the fiber strand 9 at an edge of the suction slit 16, which increases the condensing effect.

The end of the condensing zone 10 is defined by a nipping roller 17, which drives the transport belt 14 by means of friction. The nipping roller 17 is pressed against the transport belt 14 and the suction channel 11, and forms a so-called delivery nipping line 18, which functions as a twist block against the spinning twist in such a way that the fiber strand 9 is free from all spinning twist in the condensing zone 10. The suction slit 16 extends up to the delivery nipping line 18. Directly downstream of the delivery nipping line 18, the forming thread 19 receives its spinning twist, whereby it is fed in delivery direction B to a twist device (not shown), for example a ring spindle.

The transport belt 14, driven by friction via the nipping roller 17, slides, as mentioned above, on a sliding surface 13 of the suction channel 11. The sliding surface 13 must, for example by means of a suitable coating, be so designed that the lowest possible sliding resistance acts against the transport belt 14. On the other hand, the surface of the nipping roller 17 as well as the transport belt 14 must be designed in such a way that the transport belt 14 is driven without any slip. The present invention is primarily concerned with the surface structure of the transport belt 14 for achieving a suitable friction drive, and less concerned with the design of the sliding surface 13 and the nipping roller 17.

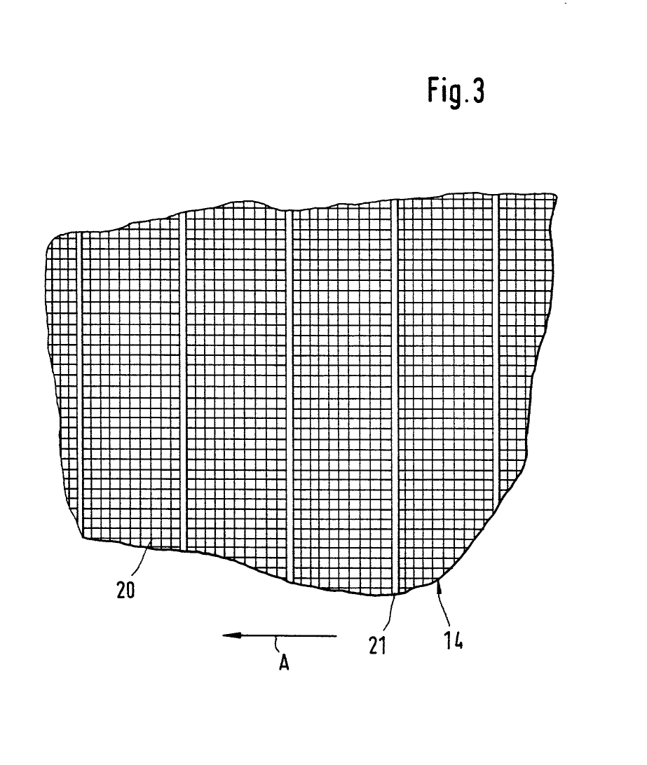

The actual present invention is explained below in more detail with the aid of FIG. 3 which shows a greatly enlarged section of a transport belt 14. The transport direction A is shown in FIG. 3 by an arrow.

The transport belt 14 is woven from very fine synthetic threads 20, preferably filament threads. They form all threads in transport direction A and a large percent of the threads transversely hereto. It is provided that in order to create a homogenous airstream, the free air flow surface measures at least 22%, and the inner mesh width measures no more than 0.08 mm. The diameter of the fine threads 20 should be preferably smaller than the inner mesh width and preferably smaller than 0.06 mm.

Coarse threads 21 are woven at effective intervals into the transport belt 14 in transverse direction, which coarse threads not only reinforce the transport belt 14 in lateral direction, but whose structure is such that the friction between the nipping roller 17 and the transport belt 14 is increased. The diameter of the coarse threads 21 should measure at least ten times the diameter of the fine threads 20, whereby these coarse threads 21 can be additionally provided with a twist. The friction drive can be improved further in that the coarse threads 21 take the form of a ply yarn of two twisted single threads.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. An air-permeable, woven transport belt made of fine synthetic threads, which transport belt is provided for a friction drive by a nipping roller and for simultaneous sliding over a stationary sliding surface, and for transporting a fiber strand to be condensed through a suctioned condensing zone of a spinning machine, whereby at regular intervals coarse synthetic threads are woven into the transport belt transversely to the transport direction of the fiber strand, the structure of the coarse threads being such that they increase the friction between the nipping roller and the transport belt.

2. A transport belt according to claim 1, wherein the diameter of the coarse threads measures at least ten times the diameter of fine threads forming a perforation section of the belt.

3. A transport belt according to claim 1, wherein the coarse threads are provided with a twist.

4. A transport belt according to claim 2, wherein the coarse threads are provided with a twist.

5. A transport belt according to claim 3, wherein the coarse threads take the form of a ply yarn.

6. A transport belt according to claim 4, wherein the coarse threads take the form of a ply yarn.

7. A transport belt for transporting a fiber strand to be condensed through a condensing zone, comprising a perforation section formed of fine threads for an air suction stream which suctions the fiber strand, one side of said transport belt sliding over a stationary sliding surface and a second oppositely facing side being driven by a nipping roller when said transport belt is in an in use position on a spinning machine, and coarse threads woven into the transport belt transversely to the transport direction of the fiber strands to increase friction between the nipping roller and transport belt.

8. A transport belt according to claim 7, wherein the diameter of the coarse threads measures at least ten times the diameter of fine threads forming a perforation section of the belt.

9. A transport belt according to claim 7, wherein the coarse threads are provided with a twist.

10. A transport belt according to claim 8, wherein the coarse threads are provided with a twist.

11. A transport belt according to claim 7, wherein the coarse threads are provided with a twist.

12. A transport belt according to claim 8, wherein the coarse threads are provided with a twist.

13. A method of making a transport belt for transporting a fiber strand to be condensed over a suction area, said method comprising weaving a transport belt with a perforation pattern of fine threads, and with coarse threads woven into the transport belt transversely to an in use travel direction of the transport belt, said coarse threads being configured to increase driving friction between the transport belt and a nipping roller when in an in use position on a spinning machine.

14. A method of making a transport belt according to claim 13, wherein the diameter of the coarse threads measures at least ten times the diameter of fine threads forming a perforation section of the belt.

15. A method of making a transport belt according to claim 13, wherein the coarse threads are provided with a twist.

16. A method of making a transport belt according to claim 14, wherein the coarse threads are provided with a twist.

17. A method of making a transport belt according to claim 13, wherein the coarse threads are provided with a twist.

18. A method of making a transport belt according to claim 14, wherein the coarse threads are provided with a twist.
